(19) United States
(12) Patent Application Publication
(10) Pub. No.: US 2019/0243811 A1
(43) Pub. Date: Aug. 8, 2019

(54) GENERATION METHOD, GENERATION DEVICE, AND COMPUTER-READABLE RECORDING MEDIUM

(71) Applicant: FUJITSU LIMITED, Kawasaki-shi (JP)

(72) Inventor: Tatsuya Asai, Kawasaki (JP)

(73) Assignee: FUJITSU LIMITED, Kawasaki-shi (JP)

(21) Appl. No.: 16/262,254

(22) Filed: Jan. 30, 2019

(30) Foreign Application Priority Data
Feb. 5, 2018 (JP) 2018-018716

(51) Int. Cl. G06F 16/22; G06N 20/00

(52) U.S. Cl. CPC G06F 16/2246; G06N 20/00

(57) ABSTRACT

A non-transitory computer-readable recording medium stores therein a generation program that causes a computer to execute a process including: generating a tree structure of stumps, each of which represents smallest binary tree and has a root and two child nodes, which are a left-side child node and a right-side child node, by performing expansion according to a predetermined expansion method by connecting the root of another stump to at least either one of the two child nodes, which are the left-side child node and the right-side child node of a parent stump that does not have the root connected to another stump; and generating a binary tree from the tree structure of stumps by developing each stump constituting the tree structure of stumps into a binary tree.

### CROSS-REFERENCE TO RELATED APPLICATION

This application is based upon and claims the benefit of priority of the prior Japanese Patent Application No. 2018-018716, filed on Feb. 5, 2018, the entire contents of which are incorporated herein by reference.

### FIELD

The embodiments discussed herein are related to a computer-readable recording medium, a generation method, and a generation device.

### BACKGROUND

A technology is known in which binary trees, which represent one of the fundamental data structures in information processing, are enumerated. For example, a technology is known in which, regarding binary trees having leaf nodes representing base volumes and non-leaf nodes representing binomial-commutative-operation combinatorial volumes, the binary trees are corrected by performing a design operation that serves as a trigger for adding or deleting leaf nodes, and on the other hand the number of weak leaf nodes is minimized.

Moreover, a technology is known for efficiently searching for nearest data points using binary trees based on principal component analysis. In this technology, a database for approximate nearest neighbor search is used, in which vector data is classified in a hierarchical structure of binary trees having a first child cluster and a second child cluster according to the principal component score; and query vector data is used. In this technology, the initial value of the target cluster for searching is set as the root node of a binary tree; and the inner product with a first principal component vector, which is obtained by performing correction by deducting the average vector of the target cluster from the query and by performing principal component analysis of the target cluster, is treated as the query principal component score with respect to the target cluster. In this technology, if the query principal component score is equal to or smaller than zero, then the first child cluster is treated as the search cluster; and, if the query principal component score is greater than zero, then the second child cluster is treated as the search cluster. Then, the search is repeated till the marginal hierarchy is reached. In this technology, the vector data that belongs to the search cluster of the marginal hierarchy and that has the shortest distance from the query is treated as the nearest data.

[Patent Document 1] Japanese Laid-open Patent Publication No. 2015-64876

[Patent Document 2] Japanese Laid-open Patent Publication No. 2013-73256

However, in the technologies mentioned above, at the time of adding one node at a time, there are times when trees other than binary trees are also enumerated. Hence, it requests time for the enumeration of trees. Besides, it requests a large cost for retrieving only the binary trees from the enumerated trees.

### SUMMARY

According to an aspect of an embodiment, a non-transitory computer-readable recording medium stores therein a generation program that causes a computer to execute a process including: generating a tree structure of stumps, each of which represents smallest binary tree and has a root and two child nodes, which are a left-side child node and a right-side child node, by performing expansion according to a predetermined expansion method by connecting the root of another stump to at least either one of the two child nodes, which are the left-side child node and the right-side child node of a parent stump that does not have the root connected to another stump; and generating a binary tree from the tree structure of stumps by developing each stump constituting the tree structure of stumps into a binary tree, wherein in the predetermined expansion method, in the tree structure of stumps, when target stump for connection is present in rightmost stump series, which is a series of stumps obtained by tracking stumps from the parent stump via stumps connected to the right-side child nodes or via stumps connected to the left-side child nodes when there is no stump connected to the right-side child node, and is a marginal stump having no stump connected to the right-side child node and the left-side child node thereof, expansion is performed by connecting a new stump to right-side child node or left-side child node of the target stump for connection, in the tree structure of stumps, when target stump for connection is a non-marginal stump present in the rightmost stump series of the tree structure of stumps, expansion is performed by connecting a new stump only to the right-side child node of the target stump for connection, in the tree structure of stumps, when target stump for connection is a marginal stump present in leftmost stump series, which is a series of stumps obtained by tracking stumps from the parent stump via stumps connected to the left-side child nodes or via stumps connected to the right-side child nodes when there is no stump connected to the left-side child node, expansion is performed by connecting a new stump to the right-side child node or the left-side child node of the target stump for connection, and in the tree structure of stumps, when target stump for connection is a non-marginal stump present in the leftmost stump series of the tree structure of stumps, expansion is performed by connecting a new stump only to the left-side child node of the target stump for connection.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary binary tree according to a first embodiment;

FIG. 2 is a diagram illustrating an example of a binary tree enumeration operation according to a standard technology;

FIG. 3 is a diagram illustrating an example of a binary tree enumeration operation according to the first embodiment;

FIG. 4 is a diagram illustrating an example of a generation device according to the first embodiment;

FIG. 5 is a diagram illustrating an exemplary stack according to the first embodiment;

FIG. 6 is a diagram illustrating an example of a binary tree database (DB) according to the first embodiment;

FIG. 7 is a diagram illustrating an example of a condition storing unit according to the first embodiment;

FIG. 8 is a diagram illustrating an exemplary stump according to the first embodiment;

FIG. 9 is a diagram illustrating an exemplary correspondence relationship between the binary trees and the stacks according to the first embodiment;

FIG. 10 is a diagram illustrating an exemplary collection of binary trees generated according to the first embodiment;

FIG. 11 is a flowchart for explaining an example of a generation operation performed according to the first embodiment;

FIG. 12 is a flowchart for explaining an example of an enumeration operation performed according to the first embodiment;

FIG. 13 is a flowchart for explaining an example of an expansion operation performed according to the first embodiment;

FIG. 14 is a diagram illustrating an example of an inspection operation according to a second embodiment; and

FIG. 15 is a diagram illustrating an exemplary computer that executes a generation program.

### DESCRIPTION OF EMBODIMENT(S)

Preferred embodiments will be explained with reference to accompanying drawings. However, the disclosed technology is not limited by the embodiments described below. Moreover, the embodiments can be appropriately combined without causing any contradiction.

### [a] First Embodiment

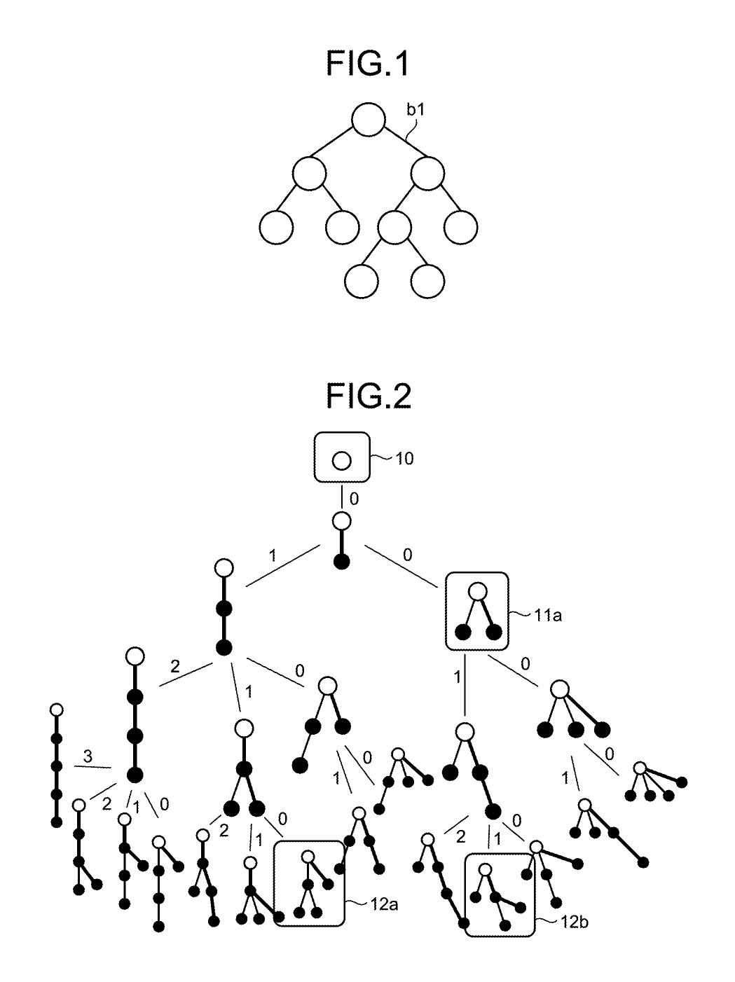

A generation device 100 (described later) according to a first embodiment generates a binary tree as illustrated in FIG. 1. FIG. 1 is a diagram illustrating an exemplary binary tree according to the first embodiment. As illustrated in FIG. 1, a binary tree b1 generated by the generation device 100 includes nodes having two child nodes on the right and left sides and includes nodes having no child nodes. For example, the binary tree b1 according to the first embodiment neither includes nodes having only one child node nor includes nodes having three or more child nodes.

In order to generate the binary tree b1 as illustrated in FIG. 1, according to a standard technology, for example, a rightmost expansion method is implemented in which the operation of adding a new node to the rightmost node of a tree is performed in a repeated manner. FIG. 2 is a diagram illustrating an example of a binary tree enumeration operation according to a standard technology. As illustrated in FIG. 2, for example, according to a standard technology such as the rightmost expansion method, firstly, a node 10 not having any child nodes is generated and then a child node is assigned to the node 10, so that a tree made of two nodes is generated. Then, according to a standard technology, a new node is added either to the node 10 or to the child node of the node 10, so that a tree made of three nodes is generated. At this stage, a binary tree 11a representing the simplest binary tree gets generated.

According to a standard technology, the operation of adding a new node to the rightmost node of the tree is further performed in a repeated manner and a tree made of more nodes is generated. As a result, binary trees 12a and 12b get generated. In this way, according to a standard technology, at the time of generating the three binary trees 11a, 12a, and 12b; 20 or more trees get generated. Hence, it requests time for generating and enumerating binary trees.

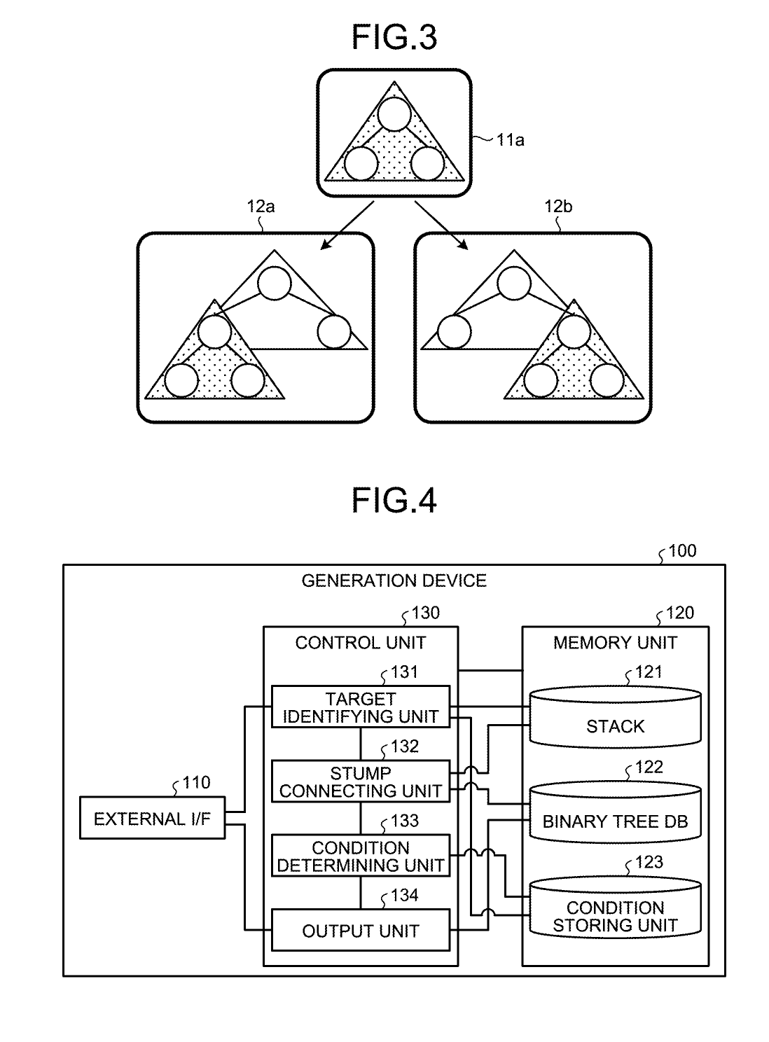

In comparison, as illustrated in FIG. 3, the generation device 100 according to the first embodiment connects a “stump”, which is made of three nodes including a parent node and two child nodes on the right and left sides, to other stumps. FIG. 3 is a diagram illustrating an example of a binary tree enumeration operation according to the first embodiment. In the following explanation, a child node on the left-hand side is sometimes called a “left-side child node”, and a child node on the right-hand side is sometimes called a “right-side child node”.

For example, the generation device 100 connects a new stump to the left-side child node of a stump 11 of the binary tree 11a, and generates the binary tree 12a. Moreover, for example, the generation device 100 connects a new stump to the right-side child node of the stump 11, and generates the binary tree 12b. That is, the generation device 100 only generates binary trees as illustrated in FIG. 1, and neither generates nodes having only one child node nor generates nodes having three or more child nodes.

Moreover, the generation device 100 according to the first embodiment identifies, as a “rightmost stump series”, a series of stumps obtained by tracking the stumps from the root stump, which is not connected to other stumps, via the stumps connected to the right-side child nodes or via the stumps connected to the left-side child nodes when there is no stump connected to the right-side child node. In the following explanation, a stump that belongs to the rightmost stump series and that represents the stump to which a new stump is to be connected is sometimes referred to as the “target stump for connection”.

From among the stumps belonging to the rightmost stump series, regarding the “bottom-rightmost stump” that represents a marginal stump which neither has a stump connected to the left-side child node thereof nor has a stump connected to the right-side child node thereof, the generation device 100 can connect a stump to one or both of the left-side child node and the right-side child node of the bottom-rightmost stump. Moreover, from among the stumps belonging to the rightmost stump series, regarding any other stump other than the marginal stump, the generation device 100 can connect a stump to only the right-side child node of the concerned stump. Meanwhile, regarding the stumps having other stumps connected to the left-side child node and the right-side child node as well as regarding the stumps not belonging to the rightmost stump series, the generation device 100 does not connect any new stump.

That is, the generation device 100 connects a stump, which includes a parent node and two child nodes on the right and left sides, only to the right-side child node of the rightmost stump series, which represents a series of stumps obtained by tracking the stumps from the root stump via the stumps connected to the right-side child nodes or via the stumps connected to the left-side child nodes when there is no stump connected to the right-side child node, and to the left-side child nodes of the stumps in the bottommost level of the rightmost stump series. As a result, the binary trees can be enumerated at a fast rate.

Functional Blocks

Explained below with reference to FIG. 4 is an example of the generation device 100 according to the first embodiment. FIG. 4 is a diagram illustrating an example of the generation device according to the first embodiment. As illustrated in FIG. 4, the generation device 100 according to the first embodiment includes an external I/F 110, a memory unit 120, and a control unit 130. The generation device 100 is implemented using, for example, a standalone computer. However, that is not the only possible case. Alternatively, the generation device 100 can be a server computer capable of performing mutual communication with computers in a wireless manner or a wired manner; or the generation device 100 can be implemented in cloud.

The external I/F 110 controls the communication with other computers, such as the terminal (not illustrated) of a user (non-illustrated) of the generation device 100. For example, the external I/F 110 is a communication interface such as a network interface card (NIC). However, that is not the only possible case. Alternatively, the external I/F 110 can be configured using an input device such as a keyboard or an output device such as a display.

The memory unit 120 is an example of a memory device for storing, for example, a variety of data such as computer programs executed by the control unit 130, and represents a memory or a processor. The memory unit 120 includes a stack 121, a binary tree DB 122, and a condition storing unit 123. In the following explanation a database is sometimes written as a “DB”.

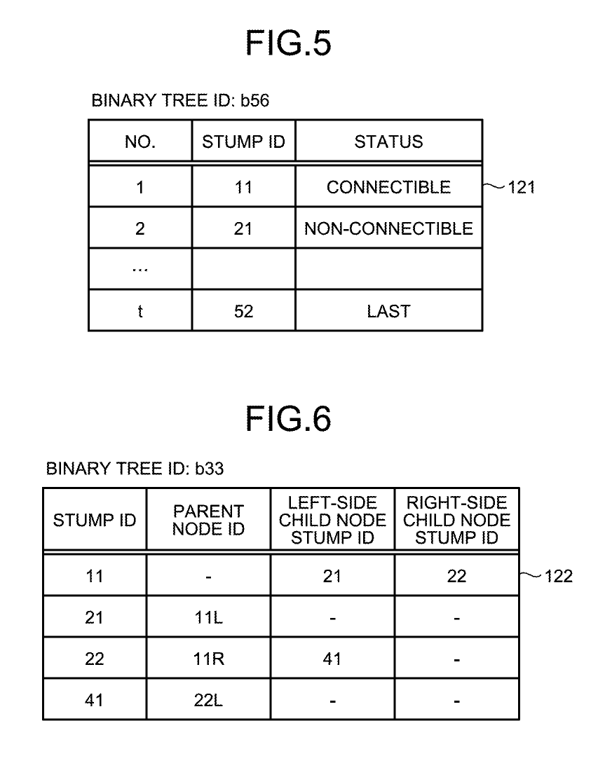

The stack 121 is used to store information about whether or not a new stump can be connected to each stump belonging to the rightmost stump series of a binary tree. FIG. 5 is a diagram illustrating an exemplary stack according to the first embodiment. As illustrated in FIG. 5, in the stack 121, a “stump ID (Identifier)” item and a “status” item are stored in a corresponding manner to a “No.” item. The information stored in the stack 121 is input by, for example, a target identifying unit 131 (described later), and is input or updated by a stump connecting unit 132.

For example, the stack 121 includes one table for each generated binary tree; and each stump belonging to the rightmost stump series in a binary tree is stored as a single record. For example, in FIG. 5 is illustrated a table that corresponds to a generated binary tree which has a binary tree ID “b56” for unique identification thereof and which includes “t” number of stumps belonging to the rightmost stump series. In the following explanation, a binary tree having a binary tree ID “bXX” is sometimes simply written as a “binary tree bXX”.

In the following explanation, a binary tree that is generated is sometimes written as “b”, and the stack corresponding to a binary tree is sometimes written as “s”. Moreover, the combination of a binary tree b and a stack s is sometimes written as “(b, s)”, and the set of combinations (b, s) having a size n is sometimes written as “Bn”. In the following explanation, the size n of a binary tree b indicates, for example, the number of stumps included in the binary tree b. However, that is not the only possible case. Alternatively, the number of levels in a binary tree b or the number of nodes included in a binary tree b can be treated as the size n.

With reference to FIG. 5, the “No.” item indicates the sequence of the stumps belonging to the rightmost stump series of a binary tree b. The “stump ID” indicates the information enabling unique identification of each stump that belongs to the rightmost stump series and that corresponds to a record. The “status” item indicates whether or not other stumps can be connected to each stump that belongs to the rightmost stump series and that corresponds to a record. In the following explanation, regarding each record of the stack 121 corresponding to a stump belonging to the rightmost stump series, “status” is sometimes written as “cell”. Moreover, in the following explanation, the stump having a stump ID “XX” is sometimes simply written as a “stump XX”.

With reference to FIG. 5, “connectible” indicates that a new stump can be connected only to the right-side child node of the stump that belongs to the rightmost stump series and that corresponds to the concerned cell. On the other hand, “not connectible” indicates that a new stump can neither be connected to the right-side child node nor be connected to the left-side child node of the stump that belongs to the rightmost stump series and that corresponds to the concerned cell. Moreover, “last” indicates that the stump that belongs to the rightmost stump series and that corresponds to the concerned cell is the bottom-rightmost stump. That is, a new stump can be connected to one or both of the right-side child node and to the left-side child node of the stump that belongs to the rightmost stump series and that corresponds to the concerned cell having the status “last”.

The binary tree DB 122 is used to store the information related to each generated binary tree. FIG. 6 is a diagram illustrating an example of the binary tree DB according to the first embodiment. As illustrated in FIG. 6, in the binary tree DB 122, for example, a “stump ID” item, a “parent node ID” item, a “left-side child node stump ID”, and a “right-side child node stump ID” are stored in a corresponding manner. The information stored in the binary tree DB 122 is input by, for example, the stump connecting unit 132 (described later).

For example, the binary tree DB 122 includes one table for each generated binary tree; and each stump included in a binary tree is stored as a single record. For example, in FIG. 6 is illustrated a table that corresponds to a generated binary tree having the binary tree ID “b33” and having “four” stumps.

With reference to FIG. 6, the “parent node ID” item represents the information enabling unique identification of the node of the stump to which the stump having the concerned stump ID is connected. Moreover, for example, in the “parent node ID” item, “L” indicating the left-side child node or “R” indicating the right-side child node is attached to the stump ID of the parent node. If the stump having the concerned stump ID is a stump including the root of the binary tree, then “-” is written as the parent node ID.

With reference to FIG. 6, for example, the stump having the stump ID “21” is connected to the left-side child node of the stump having the stump ID “11”, and the stump having the stump ID “22” is connected to the right-side child node of the stump having the stump ID “11”. Herein, the stump ID “11” represents the stump that includes the root of the binary tree.

With reference to FIG. 6, the “left-side child node stump ID” item indicates the stump ID of the stump connected to the left-side child node of the concerned stump, and “the right-side child node stump ID” item indicates the stump ID of the stump connected to the right-side child node of the concerned stump. If there is no stump connected either to the left-side child node or to the right-side child node, then either the “left-side child node stump ID” item or the “right-side child node stump ID” item has “-” written therein. For example, regarding the stump having the stump ID “22”, the stump having the stump ID “41” is connected to the left-side child node, but there is no stump connected to the right-side child node.

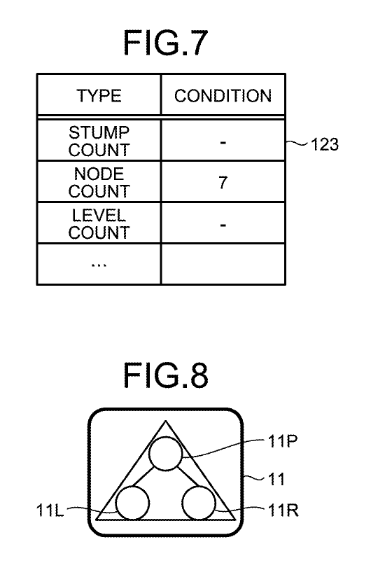

The condition storing unit 123 is used to store the information related to the conditions for ending the generation of binary trees. FIG. 7 is a diagram illustrating an example of the condition storing unit according to the first embodiment. As illustrated in FIG. 7, for example, the condition storing unit 123, a “type” item and a “condition” item are stored in a corresponding manner. The information stored in the condition storing unit 123 is input by, for example, the target identifying unit 131.

With reference to FIG. 7, the “type” item indicates the type of the condition, and the “condition” item indicates the specific condition for the concerned type. For example, in FIG. 7, it is indicated that there is no condition set for the type “stump count” indicating the number of stumps included in a binary tree, and for the type “level count” indicating the number of levels of the nodes included in a binary tree. However, it is indicated that, when “7” is set as the condition for the type “node count”, the generation of binary trees is ended.

Returning to the explanation with reference to FIG. 4, the control unit 130 is a processing unit that controls the generation device 100 in entirety, and examples thereof include a processor. The control unit 130 includes the target identifying unit 131, the stump connecting unit 132, a condition determining unit 133, and an output unit 134. Herein, the target identifying unit 131, the stump connecting unit 132, the condition determining unit 133, and the output unit 134 represent examples of electronic circuits of the processor or represent examples of processes executed by the processor.

The target identifying unit 131 receives a start instruction for starting a generation operation to generate binary trees, and identifies the stump to which other stumps are to be connected and identifies the left-side child node and the right-side child node. For example, when a start request for starting the generation operation to generate binary trees is received from the terminal of a user of the generation device 100 via the external I/F 110, the target identifying unit 131 generates the binary tree b having only a single stump and thus having the size of “1”. Moreover, the target identifying unit 131 stores, in the condition storing unit 123, the information that is related to the condition for ending the generation of binary trees and that was received in the start instruction for starting the generation operation to generate binary trees. Meanwhile, the target identifying unit 131 represents an example of a tree structure generating unit.

The target identifying unit 131 generates the stack s that has the length of “1” and that is meant for managing the rightmost stump series of the binary tree b, and stores “last” in the only cell s[1] of the stack s. Moreover, the target identifying unit 131 generates a combination B(b, s) between the binary tree b and the stack s. That is, the target identifying unit 131 generates a parent stump that is not connected to any other root and that has the left-side child node and the right-side child node to which other stumps can be connected.

Explained below with reference to FIG. 8 is a stump according to the first embodiment. FIG. 8 is a diagram illustrating an exemplary stump according to the first embodiment. As illustrated in FIG. 8, the stump 11 has a parent node 11P, a left-side child node 11L, and a right-side child node 11R. The generation device 100 can connect a single stump to each of the left-side child node 11L and the right-side child node 11R.

The stump connecting unit 132 connects stumps to the binary tree b and generates binary trees. The stump connecting unit 132 performs the operation of connecting new stumps in a repeated manner with respect to all generated binary partition tress. Herein, the stump connecting unit 132 represents an example of a connecting unit.

For example, regarding the binary tree b included in the combination B(b, s), the stump connecting unit 132 connects stumps by referring to the stack s. In that case, since it is indicated that the cell s[1] of the stack s is set to have the status “last”, that is, since it is indicated that the target stump for connection is the bottom-rightmost stump of the binary tree b; the stump connecting unit 132 generates a binary tree by connecting a stump to the left-side child node of the target stump for connection and generates a binary tree by connecting a stump to the right-side child node of the target stump for connection.

For example, the stump connecting unit 132 connects a new stump to the left-side child node of the target stump for connection and generates a binary tree “Left”. Moreover, the stump connecting unit 132 updates the cell s[1] to “connectible”, and generates a stack “s Left” in which the status “last” is registered in the cell s[2] corresponding to the stump connected to the left-side child node.

Moreover, when the cell s[1] of the stack s is set to have the status “last”, the stump connecting unit 132 connects a new stump to the right-side child node of the target stump for connection and generates a binary tree “Right” At that time, the stump connecting unit 132 updates the cell s[1] to “non-connectible”, and generates a stack “s Right” in which the status “last” is registered in the cell s[2] corresponding to the stump connected to the right-side child node. That is, the stump connecting unit 132 does not connect a new stump to the left-side child node, which represents of the target stump for connection, in the binary tree “Right”.

When the cell s[i] corresponding to the target stump for connection is determined to have the status “connectible”, the stump connecting unit 132 connects a new stump to the right-side child node of the target stump for connection and generates a binary tree “New”. At that time, the stump connecting unit 132 generates a stack “s_New” in which the cell s[i] is updated to have the status “non-connectible”.

Moreover, at the time of generating the stack “s_New”, the stump connecting unit 132 updates the stump corresponding to the cell s[i+1] from the stump connected to the left-side child node of the target stump for connection to the new stump connected to the right-side child node of the target connection for stump. For example, the stump connecting unit 132 updates the stump ID corresponding to the cell s[i+1] of the stack 121. That is, the stump connecting unit 132 excludes, from the rightmost stump series, the stump connected to the left-side child node of the target stump for connection.

Moreover, if the cell s[i+1] is set to a status other than the status “last”, then the stump connecting unit 132 updates the status to “last”. That is, the stump connecting unit 132 identifies, as the bottom-rightmost stump, the stump that is newly connected to the right-side child node of the target stump for connection. In that case, although the bottom-rightmost stump is changed, the height of the bottom-rightmost stump remains the same.

Moreover, in the stack s_New, if it is determined that a cell in the lower level of the cell s[i+1], such as the stump connected to the left-side child node of the target stump for connection, further has a stump connected thereto; then the stump connecting unit 132 deletes the concerned cell. That is, the stump connecting unit 132 excludes, from the rightmost stump series, the stump that is further connected to the stump which corresponds to the cell s[i+2] and which is connected to the left-side child node of the target stump for connection.

Moreover, the stump connecting unit 132 performs an expansion operation, which is meant for connecting a new stump to the right-side child node or the left-side child node of the target stump for connection, with respect to each rightmost stump series included in the binary trees. For example, every time a stump is connected to an upper-level stump of the rightmost stump series, the stump connecting unit 132 increments a counter m by one, and performs the operations in a repeated manner till the counter m reaches the length t of the stack s.

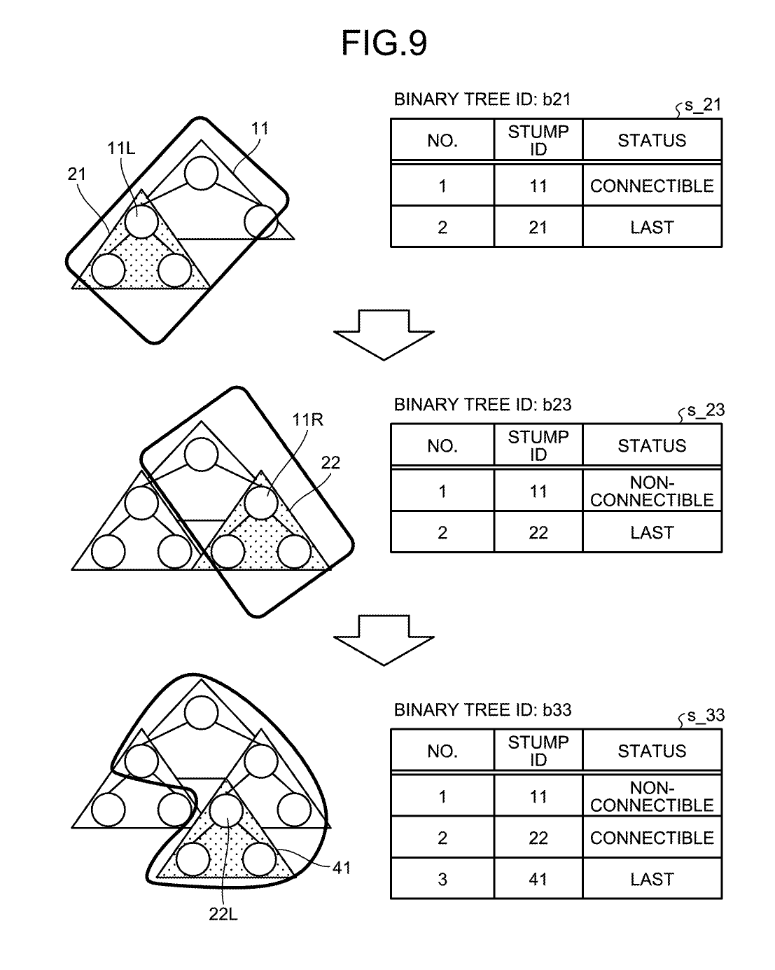

Explained below with reference to FIG. 9 is a flow of operations performed by the stump connecting unit 132 for generating binary trees and for updating the stack. FIG. 9 is a diagram illustrating an exemplary correspondence relationship between the binary trees and the stacks according to the first embodiment. With reference to FIG. 9, firstly, the stump connecting unit 132 connects a new stump to a binary tree b11 having only a single stump. For example, the stump connecting unit 132 connects a new stump 21 to the left-side child node 11L of the stump 11 included in the binary tree b11, and generates a binary tree b21.

In that case, since no stump is connected to the right-side child node of the stump 11 representing the root stump, the rightmost stump series is obtained by tracking via the stump 21 connected to the left-side child node. Thus, the stumps 11 and 21 belong to the rightmost stump series, and the stump 21 further corresponds to the bottom-rightmost stump. Moreover, the stump connecting unit 132 can connect a new stump only to the right-side child node of the stump 11, but can connect a new stump to the left-side child node as well as the right-side child node of the stump 21.

At that time, the stump connecting unit 132 generates a new stack s_21 in which the status “connectible” is stored in the cell s[1] corresponding to the stump 11 representing a first rightmost stump series, and the status “last” is stored in the cell s[2] corresponding to the stump 21 representing a second rightmost stump series.

Subsequently, the stump connecting unit 132 connects a new stump 22 to the right-side child node 11R of the stump 11 in the binary tree b21, and generates a binary tree b23. In this case, the rightmost stump series represents the series obtained by tracking via the stump 22 connected to the right-side child node of the stump 11 representing the root stump. As a result, the stump 21 gets excluded from the rightmost stump series.

In this case, the stump connecting unit 132 generates a new stack s_23 in which the stump ID of the record corresponding to the second rightmost stump series in the stack s_21 is updated from “21” to “22”. Moreover, the stump connecting unit 132 stores the status “last” in the cell s_23[2] corresponding to the stump 22 in the stack s_23.

Moreover, since a new stump is connected to the left-side child node 11L as well as the right-side child node 11R of the stump 11, the stump connecting unit updates the cell s_23[1], which corresponds to the first rightmost stump series in the stack s_23, to have the status “non-connectible”.

Subsequently, the stump connecting unit 132 connects a new stump 41 to a left-side child node 22L of the stump 22 and generates a binary tree b33. In this case, the newly-connected stump 41 is included in the series obtained by tracking via the stump 22, which is connected to the right-side child node of the stump 11 representing the root stump 11, and represents a marginal stump. Hence, the stump 41 corresponds to the bottom-rightmost stump.

Herein, the stump connecting unit 132 generates a new stack s_33 in which a record is added corresponding to a third rightmost stump series in the stack s_23. Then, the stump connecting unit 132 stores the stump ID “41” corresponding to the cell s_33[3] of the stack s_33. Moreover, the stump connecting unit 132 updates the cell s_33[2], which corresponds to the stump 22 in the stack s_33, to have the status “connectible”. However, the stump connecting unit 132 does not update the cell s_33[1] corresponding to the stump in the upper level than the stump 22 representing the target stump for connection.

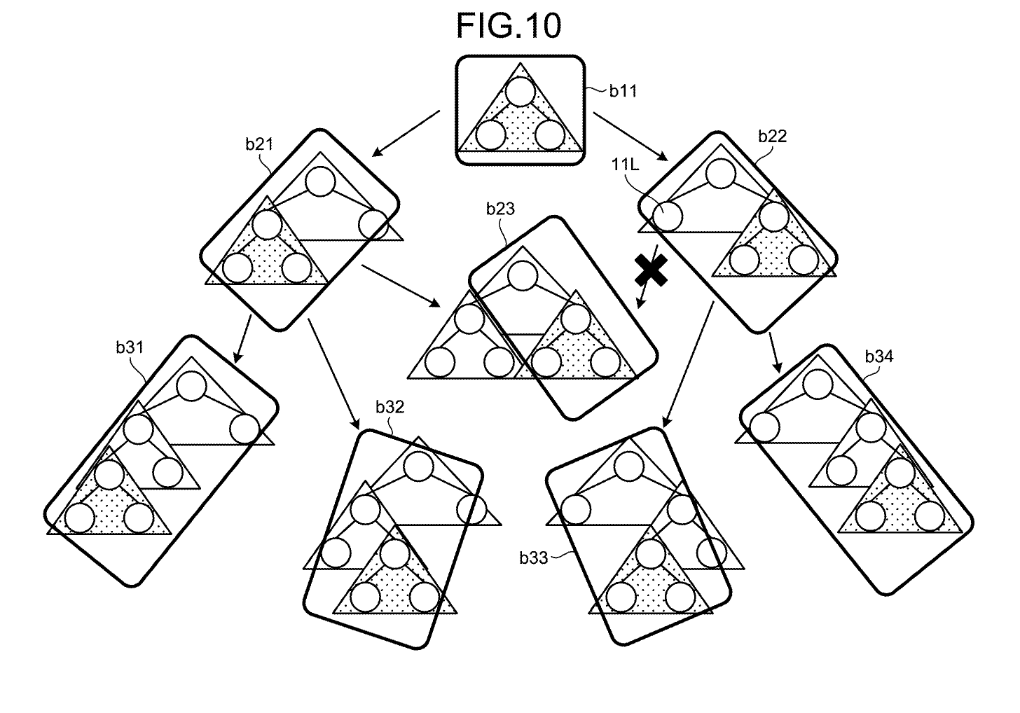

Regarding the binary trees generated as a result such operations, the explanation is given with reference to FIG. 10. FIG. 10 is a diagram illustrating an exemplary collection of binary trees generated according to the first embodiment. In FIG. 10 is illustrated an example of enumeration of the collection of generated binary trees when maximum size N of binary trees is set to “3”.

In an identical manner to the example illustrated in FIG. 9, the stump connecting unit 132 generates the binary tree b21 from the binary tree b11, and generates the binary tree b23 from the binary tree b21. Meanwhile, since the binary tree b33 has the size n set to “4”; it is not enumerated in the example illustrated in FIG. 10.

In the binary tree b22, the cell s_22[1] corresponding to the stump 11 of the stack s_22 has the status “non-connectible”. Hence, the stump connecting unit 132 does not generate the binary tree b23 by connecting a new stump to the left-side child node 11L of the stump 11. As a result, the stump connecting unit 132 holds down the redundant generation of binary trees.

Returning to the explanation with reference to FIG. 4, the condition determining unit 133 determines the condition for deciding whether or not to end the generation operation for generating binary trees. For example, during the operation for enumerating the binary trees, the condition determining unit 133 determines whether or not all binary trees having the size n are enumerated. If all binary trees are not yet enumerated, then the condition determining unit 133 again performs the operation of enumerating the binary trees. When all binary trees are enumerated, the size n of the binary trees is incremented by one, and the system control returns to the operation of enumerating the binary trees having the size n.

Moreover, for example, during the expansion operation for connecting the stumps to the binary trees, the condition determining unit 133 determines whether or not the operations are completed till the last cell s[t] of the stack corresponding to the binary tree b. For example, the condition determining unit 133 performs the operations in a repeated manner until the counter m, which is incremented by the stump connecting unit 132, reaches the length t of the stack s. If the operations are not completed till the last cell s[t] of the stack, then the condition determining unit 133 performs the expansion operation in a repeated manner. When the operations are completed till the last cell s[t] of the stack, the system control returns to the operation for enumerating the subsequent binary tree.

Moreover, for example, the condition determining unit 133 refers to the condition storing unit 123 and determines whether or not the generated binary trees satisfy the stored conditions. For example, when the condition storing unit 123 as illustrated in FIG. 7 is referred to, the condition determining unit 133 determines whether the size n of the generated binary trees has reached the maximum size N of binary trees. If the size n has not reached the maximum size N of binary trees, then the condition determining unit 133 performs the generation operation for generating binary trees. When the size n reaches the maximum size N of binary trees, the condition determining unit 133 instructs the output unit 134 to output the binary trees.

Subsequently, the output unit 134 outputs the binary trees b included in the set Bn. For example, the output unit 134 outputs, to the terminal of the user via the external I/F 110, a list of binary trees enumerated as illustrated in FIG. 10. Alternatively, the output unit 134 can output the table of the binary tree DB 122 as illustrated in FIG. 6. Herein, the output unit 134 is an example of a binary tree generating unit.

Flow of Operations

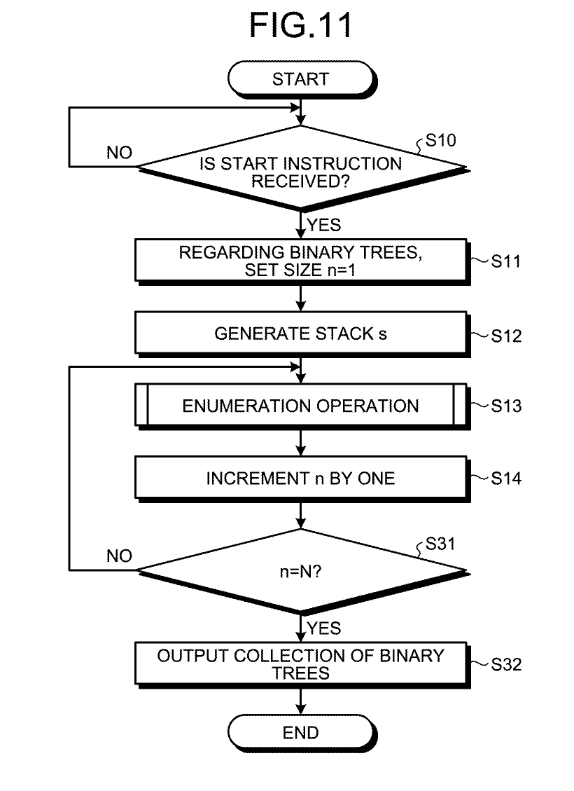

Explained below with reference to FIGS. 11 to 13 are the operations performed according to the first embodiment. FIG. 11 is a flowchart for explaining an example of the generation operation performed according to the first embodiment. As illustrated in FIG. 11, the target identifying unit 131 of the generation device 100 waits for the reception of a start instruction from the terminal of a user for starting the generation operation to generate binary trees (No at S10).

When a start instruction is received (Yes at S10), the target identifying unit 131 generates the binary tree b having the size of “1”, that is, generates the binary tree b including only a single stump; and sets the size n of the binary tree b to “1” (S11). Then, the target identifying unit 131 generates the stack s that has the length of “1” and that is meant for managing the rightmost stump series of the binary tree b (S12), and registers the status “last” in the concerned cell. Subsequently, the target identifying unit 131 generates the combination B(b, s) of the binary tree b and the stack s.

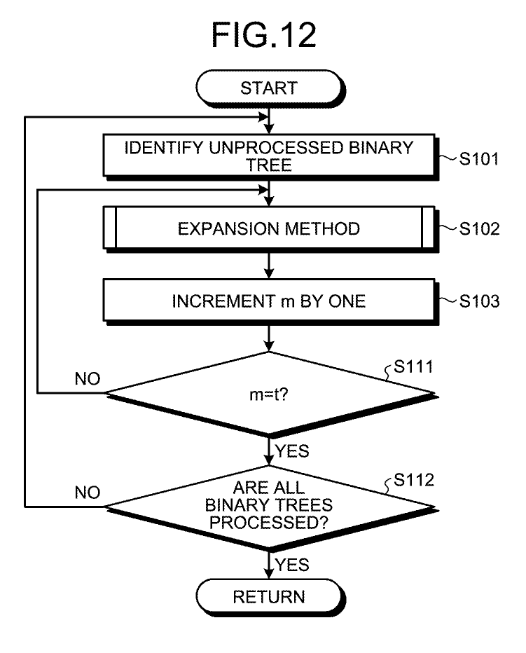

Then, the stump connecting unit 132 performs the enumeration operation (S13). FIG. 12 is a flowchart for explaining an example of the enumeration operation performed according to the first embodiment. As illustrated in FIG. 12, the stump connecting unit 132 identifies, from the set Bn of the combinations of the binary trees b and the stacks s, a combination of the binary tree and the stack (S101). Then, the stump connecting unit 132 performs the expansion operation with respect to the unprocessed binary tree included in the identified combination of the binary tree and the stack (S102).

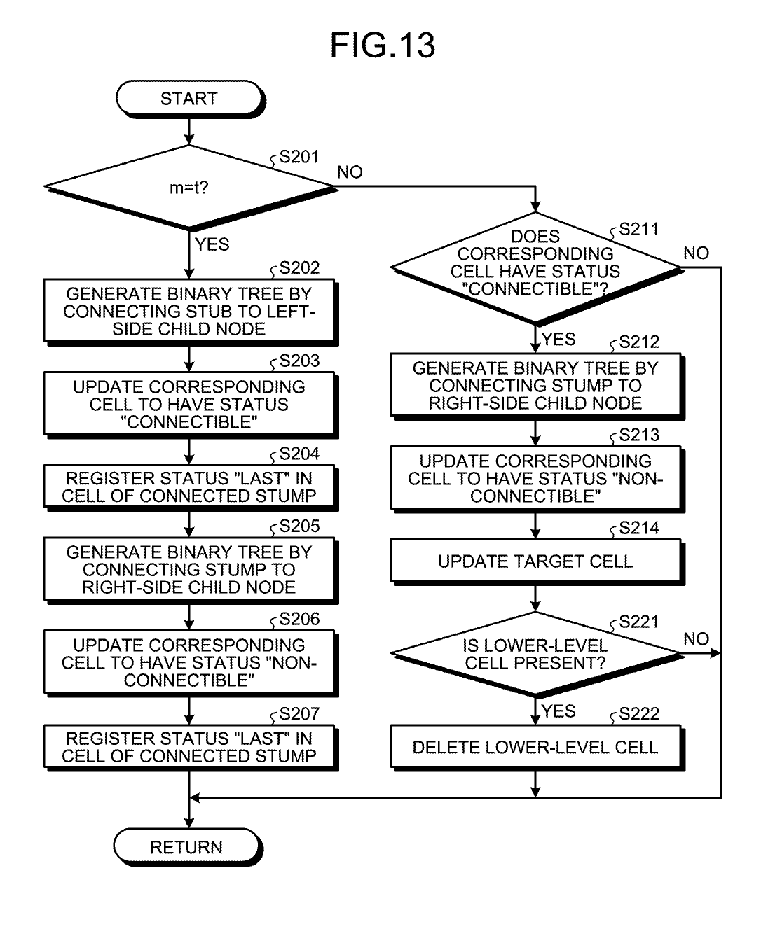

FIG. 13 is a flowchart for explaining an example of the expansion operation performed according to the first embodiment. As illustrated in FIG. 13, the stump connecting unit 132 determines whether or not the counter m has reached the length t of the stack s, that is, determines whether or not the target stump for connection is the bottom-rightmost stump (S201).

If it is determined that the counter m has reached the length t of the stack s (Yes at S201), then the stump connecting unit 132 generates a binary tree “Left” by connecting a new stump to the left-side child node of the target stump for connection (S202). Then, the stump connecting unit 132 updates the cell s[m] corresponding to the target stump for connection to have the status “connectible” (S203). Moreover, the stump connecting unit 132 generates a cell s[m+1] corresponding to the newly-connected stump, and registers the status “last” (S204).

Subsequently, the stump connecting unit 132 generates a binary tree “Right” by connecting a new stump to the right-side child node of the target stump for connection (S205). Then, the stump connecting unit 132 updates the cell s[m] to have the status “non-connectible” (S206). Moreover, the stump connecting unit 132 registers the status “last” in the cell s[m+1] corresponding to the newly-connected stump in the stack s (S207). Then, the stump connecting unit 132 adds (New, s_New) to the set Bn, and the system control returns to S10.

On the other hand, if it is determined that the counter m has not reached the length t of the stack s (No at S201), then the stump connecting unit 132 determines whether or not the cell s[m] corresponding to the stack s has the status “connectible”, that is, determines whether or not a different stump is connected to the left-side child node of the target stump for connection (S211). If it is determined that the cell s[m] does not have the status “connectible” (No at S21), it implies that the cell s[m] corresponding to the target stump for connection has the status “non-connectible” and that no new stump can be connected. Hence, the stump connecting unit 132 does not connect a new stump, and the system control returns to S102.

On the other hand, if it is determined that the cell s[m] has the status “connectible” (Yes at S211), then the stump connecting unit 132 connects a new stump to the right-side child node of the target stump for connection and generates a binary tree “New” (S212). Then, the stump connecting unit 132 updates the cell s[m] to have the status “non-connectible” (S213). Moreover, the stump connecting unit 132 changes the stump ID in the cell s[m+1] corresponding to the newly-connected stump, that is, changes the stump ID of the rightmost stump series from the stump ID of the stump connected to the left-side child node of the target stump for connection to the stump ID of the stump connected to the right-side child node of the target stump for connection (S214). At that time, if the cell s[m+1] does not have the status “last”, then the stump connecting unit 132 updates the cell s[m+1] to have the status “last”.

Subsequently, the stump connecting unit 132 determines whether or not a cell is present in the lower level of the cell s[m+1], that is, determines whether or not a different stump is further connected to the left-side child node of the target stump for connection (S221). If it is determined that a lower-level cell is not present, then the system control returns to S102. On the other hand, if it is determined that a lower level cell is present (Yes at S22), then the stump connecting unit 132 deletes that cell (S222), and the system control returns to S102.

Returning to the explanation with reference to FIG. 12, the condition determining unit 133 increments the counter m by one (S103). Then, the condition determining unit 133 determines whether or not the counter m has reached the length t of the cells of the stack s, that is, determines whether or not the operations are completed for all cells in the stack s (S111). If it is determined that the counter m has not yet reached the length t of the cells in the stack s (No at S111), then the system control returns to S102 and the condition determining unit 133 again performs the operations.

When it is determined that the counter m has reached the length t of the cells in the stack s (Yes at S111), the condition determining unit 133 determines whether or not the operations are completed for all binary trees included in the set Bn (S112). If it is determined that the operations are not yet completed for all binary trees (No at S112), then the system control returns to S101 and the condition determining unit 133 again performs the operations. When it is determined that the operations are completed for all binary trees (Yes at S112), the system control returns to S13.

Returning to the explanation with reference to FIG. 11, the condition determining unit 133 increments the size n of binary trees by one (S14). Then, for example, the condition determining unit 133 determines whether or not the size n of binary trees has reached the maximum size N of binary trees as stored in the condition storing unit 123 (S31). If it is determined that the size n of binary trees has not yet reached the maximum size N of binary trees (No at S31), then the system control returns to S13 and the condition determining unit 133 again performs the operations.

When it is determined that the size n of binary trees has reached the maximum size N of binary trees (Yes at S31), the output unit 134 outputs the collection of binary trees b as stored in the binary tree DB 122 (S32). It marks the end of the operations.

Effect

As described above, the generation device according to the first embodiment generates a tree structure of stumps, each of which represents the smallest binary tree and has a root and two child nodes, namely, the left-side child node and the right-side child node, by performing expansion by connecting the root of another stump to at least either one of the two child nodes of the parent stump that does not have its root connected to another stump. The generation device develops the stumps, constituting the tree structure of stumps, into binary trees, and generates binary trees from the tree structure of stumps. When the target stump for connection is a marginal stump present in the rightmost stump series that is obtained by tracking the stumps from the parent stump via the stumps connected to the right-side child nodes or via the stumps connected to the left-side child nodes when there is no stump connected to the right-side child node; the generation device connects a new stump to the right-side child node or the left-side child node of the target stump for connection. When the target stump for connection is a non-marginal stump present in the rightmost stump series of the tree structure of stumps, the generation device connects a new stump only to the right-side child node of the target stump for connection. As a result, the generation device can enumerate the binary trees at a fast rate.

When the target stump for connection is present in the rightmost stump series, if another stump is connected to the left-side child node of the target stump for connection and if no stump is connected to the right-side child node of the target stump for connection, the generation device connects a different new stump to the right-side child node of the target stump for connection. Alternatively, when the target stump for connection is present in the leftmost stump series, if another stump is connected to the right-side child node of the target stump for connection and if no stump is connected to the left-side child node of the target stump for connection, the generation device connects a different new stump to the left-side child node of the target stump for connection. Moreover, the generation device can implement a predetermined expansion method in a repeated manner until the number of stumps included in the tree structure of stumps or the number of levels in the tree structure of stumps reaches a predetermined number. As a result, the generation device can comprehensively generate a pattern of binary trees having a predetermined number of nodes.

When the target stump for connection is not present in the rightmost stump series that is obtained by expanding the tree structure of stumps as a result of connecting new stumps to the stumps present in the rightmost stump series, and when the target stump for connection is not present in the leftmost stump series that is obtained by expanding the tree structure of stumps as a result of connecting new stumps to the leftmost stump series; the generation device deters connecting new stumps to the target stump for connection. In the case in which the tree structure of stumps is expanded by connecting new nodes to the stumps present in the rightmost stump series, if another stump is connected to the right-side child node of the target stump for connection, or in the case in which the tree structure of stumps is expanded by connecting new nodes to the stumps present in the leftmost stump series, if another stump is connected to the left-side child node of the target stump for connection; the generation device deters connecting new stumps to the target stump for connection. As a result, the generation device can generate binary trees without causing redundancy.

### [b] Second Embodiment

Meanwhile, although the present invention has been described with reference to the abovementioned embodiment, it is also possible to implement the invention in various forms other than the abovementioned embodiment. For example, in the first embodiment, the explanation is given about a configuration in which the tree structures of binary trees are enumerated. Alternatively, there is a case in which, even when the binary trees have an identical tree structure, each node has a different label assigned thereto.

For example, it is possible to think of a case in which a first stump has a label “Is the height equal to or greater than 160 cm?” assigned to the parent node; has a label “T” (True) assigned to the left-side child node; and has a label “Is the gender female?” assigned to the right-side child node. Similarly, it is possible to think of a case in which a second stump has a label “Is the height equal to or greater than 160 cm?” assigned to the parent node; has a label “Is the gender female?” assigned to the left-side child node; and has a label “F” (False) assigned to the right-side child node.

In such a case, although the first stump and the second stump have an identical tree structure of binary trees, the binary trees are not identical when the attention is turned to the labels assigned to the nodes. For example, when binary trees are generated during the learning process such as deep learning, it is possible to think of a case in which the validness of each generated binary tree is to be monitored by focusing on the labels assigned to the nodes of that binary tree. In that regard, in the second embodiment, a configuration is generated that further enables determination about whether or not the labels assigned to the nodes are identical.

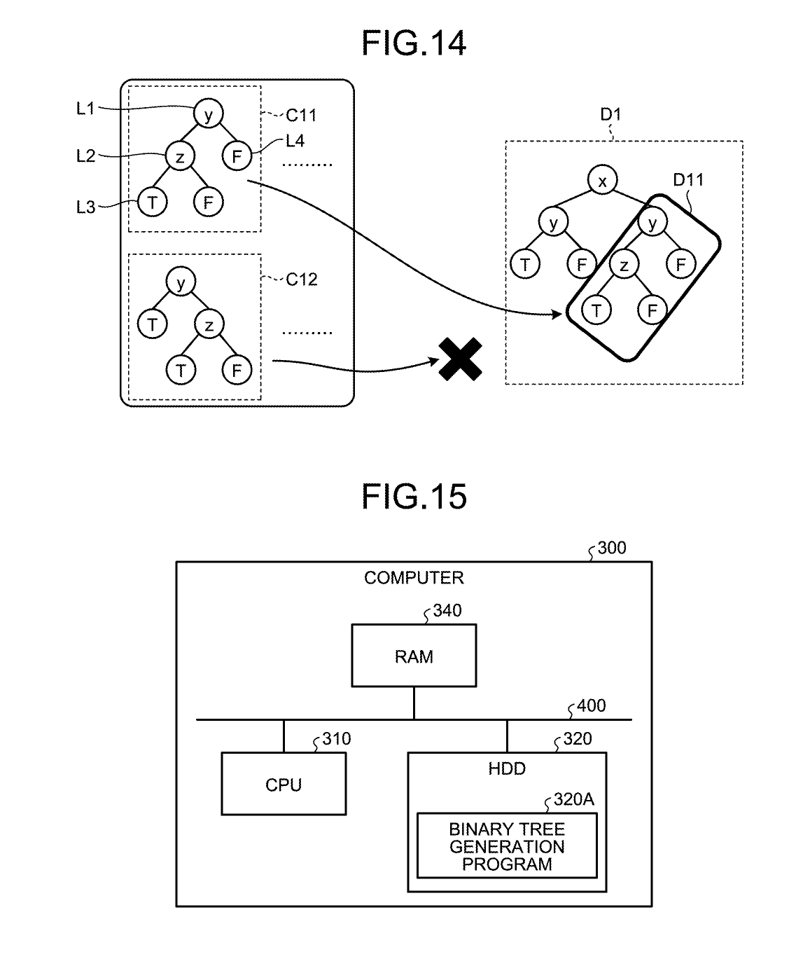

FIG. 14 is a diagram illustrating an example of an inspection operation according to the second embodiment. As illustrated in FIG. 14, a generation device 200 (not illustrated) according to the second embodiment generates a binary tree C11 and C12 having labels L1 to L4 assigned to the nodes. With reference to FIG. 14, for example, a label L1 represents “y”, a label L2 represents “z”, a label L3 represents “T”, and a label L4 represents “F”. Then, the generation device 200 compares the binary trees C11 and C12 with a different binary tree D1. For example, the binary tree D1 has a greater size than the binary trees C11 and C12.

In this case, a portion D11 of the binary tree D1 has an identical tree structure to the binary tree C11, and the labels assigned to the nodes are also identical to the binary tree C11. In contrast, as far as the binary tree C12 is concerned, neither the tree structure nor the labels assigned to the nodes match with the portion D11 of the binary tree D1. In such a case, the generation device 200 determines that the binary tree D1 includes the binary tree C11 but does not include the binary tree C12.

As described above, the generation device according to the second embodiment connects new labeled stumps to the root node and either one of the right-side child node and the left-side child node, and determines whether or not a binary tree generated using a tree structure of stumps including labeled nodes is identical to another binary tree including labeled nodes. As a result, the generation device can inspect the decision tree that is learnt.

Meanwhile, labels are assigned to, for example, the nodes of a new stump connected to the root stump or some other stump. However, that is not the only possible case. Alternatively, labels can also be assigned to the nodes of the root stump.

In the first embodiment, the explanation is given about the “rightmost stump series” that is obtained by tracking the stumps from the root stump via the stumps connected to the right-side child nodes or via the stumps connected to the left-side child nodes when there is no stump connected to the right-side child node. However, the embodiments are not limited by that example. Alternatively, for example, the generation device 100 can track the stumps from the root stump via the stumps connected to the left-side child nodes or via the stumps connected to the right-side child nodes when there is no stump connected to the left-side child node. That is, the configuration can be such that the operations are performed by interchanging the term “left-side child node” and the term “right-side child node” according to the first embodiment.

Meanwhile, the information stored in the condition storing unit 123 is only exemplary; and the configuration can be such that, from among a plurality of conditions such as the number of stumps included in a binary tree and the number of levels of the nodes included in a binary tree, it is determined whether or not either one of the conditions is satisfied or all conditions are satisfied. Moreover, the conditions are not limited to upper limit values, and alternatively a condition can have a lower limit value set therein, such as “the number of stumps is equal to or greater than five but smaller than nine”.

Meanwhile, the configuration of the tables illustrated in FIGS. 5 to 7 is only exemplary, and the tables can include some other items or can have at least either one of the abovementioned items omitted therefrom. For example, the binary tree DB 122 illustrated in FIG. 6 can have at least one of the items “parent node ID”, “left-side child node stump ID”, and “right-side child node stump ID” omitted therefrom.

System

Of the processes described in the embodiment, all or part of the processes explained as being performed automatically can be performed manually. Similarly, all or part of the processes explained as being performed manually can be performed automatically by a known method. The processing procedures, the control procedures, specific names, various data, and information including parameters described in the embodiment or illustrated in the drawings can be changed as requested unless otherwise specified.

The constituent elements of the device illustrated in the drawings are merely conceptual, and need not be physically configured as illustrated. The constituent elements, as a whole or in part, can be separated or integrated either functionally or physically based on various types of loads or use conditions. For example, the target identifying unit 131 and the stump connecting unit 132 illustrated in FIG. 4 can be integrated, or the stump connecting unit 132 and the condition determining unit 133 illustrated in FIG. 4 can be integrated. Alternatively, the condition determining unit 133 illustrated in FIG. 4 can be split into a processing unit that determines the end condition for ending the generation operation illustrated in FIG. 11, and a processing unit that determines the end condition for ending the expansion operation illustrated in FIG. 13. Moreover, the process functions performed by the device are entirely or partially realized by a central processing unit (CPU) or computer programs that are analyzed and executed by the CPU, or realized as hardware by wired logic.

Binary Partition Tree Generation Program

Meanwhile, the various operations explained in the embodiments described above can be implemented when a computer program written in advance is executed in a personal computer or in a computer system such as a workstation. Given below is the explanation of an exemplary computer system that executes a computer program having the functions identical to the embodiments described above. FIG. 15 is a diagram illustrating an exemplary computer that executes a generation program. The following explanation is given with reference to the generation device 100 according to the first embodiment. However, the same explanation is applicable to the devices corresponding to the second embodiment.

As illustrated in FIG. 15, a computer 300 includes a CPU 310, a hard disk drive (HDD) 320, and a random access memory (RAM) 340. The constituent elements 300 to 340 are connected to each other via a bus 400.

With reference to FIG. 15, the CPU 310 is an example of a processor, while the HDD 320 and the RAM 340 are examples of a memory. Other examples of the memory include various types of RAM such as a synchronous dynamic random access memory (SDRAM); a read only memory (ROM); and a flash memory. Examples of a processor include a digital signal processor (DSP), a field programmable gate array (FPGA), and a programmable logic device (PLD).

The HDD 320 is used to store a binary tree generation program 320A for implementing the functions identical to the target identifying unit 131, the stump connecting unit 132, the condition determining unit 133, and the output unit 134. Herein, the binary tree generation program 320A can be split in an appropriate manner.

The HDD 320 is used to store a variety of information. For example, the HDD 320 is used to store an operating system (OS) and a variety of data to be used in various operations.

The CPU 310 reads the binary tree generation program 320A from the HDD 320, and consequently performs the operations identical to the processing units according to the embodiments. That is, the binary tree generation program 320A enables implementation of the operations identical to the target identifying unit 131, the stump connecting unit 132, the condition determining unit 133, and the output unit 134.

Meanwhile, the binary tree generation program 320A need not be always stored in the HDD 320 from the beginning.

Alternatively, the binary tree generation program 320A can be stored in a “portable physical medium” such as a compact disc read only memory (CD-ROM), a digital versatile disc (DVD), a magneto-optical disc, and an IC card that is insertable in the computer 300. Then, the computer 300 can read the binary tree generation program 320A from the physical medium and execute it.

Still alternatively, the binary tree generation program 320A can be stored in “another computer (or server)” that is connected to the computer 300 via the Internet, a local area network (LAN), or a wide area network (WAN). Then, the computer 300 can read the binary tree generation program 320A from the other computer and execute it.

Thus, according to an aspect of the invention, binary trees can be enumerated at a fast rate.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a generation program that causes a computer to execute a process comprising:
generating a tree structure of stumps, each of which represents smallest binary tree and has a root and two child nodes, which are a left-side child node and a right-side child node, by performing expansion according to a predetermined expansion method by connecting the root of another stump to at least either one of the two child nodes, which are the left-side child node and the right-side child node of a parent stump that does not have the root connected to another stump; and
generating a binary tree from the tree structure of stumps by developing each stump constituting the tree structure of stumps into a binary tree, wherein
in the predetermined expansion method,
in the tree structure of stumps, when target stump for connection is present in rightmost stump series, which is a series of stumps obtained by tracking stumps from the parent stump via stumps connected to the right-side child nodes or via stumps connected to the left-side child nodes when there is no stump connected to the right-side child node, and is a marginal stump having no stump connected to the right-side child node and the left-side child node thereof, expansion is performed by connecting a new stump to right-side child node or left-side child node of the target stump for connection,
in the tree structure of stumps, when target stump for connection is a non-marginal stump present in the rightmost stump series of the tree structure of stumps, expansion is performed by connecting a new stump only to the right-side child node of the target stump for connection,
in the tree structure of stumps, when target stump for connection is a marginal stump present in leftmost stump series, which is a series of stumps obtained by tracking stumps from the parent stump via stumps connected to the left-side child nodes or via stumps connected to the right-side child nodes when there is no stump connected to the left-side child node, expansion is performed by connecting a new stump to the right-side child node or the left-side child node of the target stump for connection, and
in the tree structure of stumps, when target stump for connection is a non-marginal stump present in the leftmost stump series of the tree structure of stumps, expansion is performed by connecting a new stump only to the left-side child node of the target stump for connection.

2. The non-transitory computer-readable recording medium according to claim 1, wherein, in the predetermined example method,
when the target stump for connection is present in the rightmost stump series, when another node is connected to left-side child node of the target stump for connection and when no other node is connected to right-side child node of the target stump for connection, a different new node is connected to right-side child node of the target stump for connection, and
when the target stump for connection is present in the leftmost stump series, when another node is connected to the right-side child node of the target stump for connection and when no other node is connected to the left-side child node of the target stump for connection, a different new node is connected to the left-side child node of the target stump for connection.

3. The non-transitory computer-readable recording medium according to claim 1, wherein, in the predetermined expansion method, when the target stump for connection is neither present in the rightmost stump series that is obtained by expanding the tree structure of stumps as a result of connecting the new stump to stumps present in the rightmost stump series, nor present in the leftmost stump series that is obtained by expanding the tree structure of stumps as a result of connecting the new stump to stumps present in the leftmost stump series, connection of a new stump to the target stump for connection is held down.

4. The non-transitory computer-readable recording medium according to claim 1, wherein, in the predetermined expansion method,
when the tree structure of stumps is expanded by connecting the new stump to stumps present in the rightmost stump series, when another stump is connected to the right-side child node of the target stump for connection, or
when the tree structure of stumps is expanded by connecting the new stump to stumps present in the leftmost stump series, when another stump is connected to the left-side child node of the target stump for connection,
connection of a new stump to the target stump for connection is held down.

5. The non-transitory computer-readable recording medium according to claim 1, wherein the predetermined expansion method is performed in a repeated manner until number of stumps in the tree structure of stumps or number of levels in the tree structure of stumps reaches a predetermined number.

6. The non-transitory computer-readable recording medium according to claim 1, wherein, in the predetermined expansion method,
the new stump having a label assigned thereto is connected to the root node and to at least either the right-side child node or the left-side child node, and
whether or not the binary tree generated using a tree structure of stumps including the labeled nodes is identical to another binary tree including labeled nodes is determined.

7. A generation method comprising:
generating a tree structure of stumps, each of which represents smallest binary tree and has a root and two child nodes, which are a left-side child node and a right-side child node, by performing expansion according to a predetermined expansion method by connecting the root of another stump to at least either one of the two child nodes, which are the left-side child node and the right-side child node of a parent stump that does not have the root connected to another stump, by a processor; and
generating a binary tree from the tree structure of stumps by developing each stump constituting the tree structure of stumps into a binary tree, wherein
in the predetermined expansion method,
in the tree structure of stumps, when target stump for connection is present in rightmost stump series, which is a series of stumps obtained by tracking stumps from the parent stump via stumps connected to the right-side child nodes or via stumps connected to the left-side child nodes when there is no stump connected to the right-side child node, and is a marginal stump having no stump connected to the right-side child node and the left-side child node thereof, expansion is performed by connecting a new stump to right-side child node or left-side child node of the target stump for connection,
in the tree structure of stumps, when target stump for connection is a non-marginal stump present in the rightmost stump series of the tree structure of stumps, expansion is performed by connecting a new stump only to the right-side child node of the target stump for connection,
in the tree structure of stumps, when target stump for connection is a marginal stump present in leftmost stump series, which is a series of stumps obtained by tracking stumps from the parent stump via stumps connected to the left-side child nodes or via stumps connected to the right-side child nodes when there is no stump connected to the left-side child node, expansion is performed by connecting a new stump to the right-side child node or the left-side child node of the target stump for connection, and
in the tree structure of stumps, when target stump for connection is a non-marginal stump present in the leftmost stump series of the tree structure of stumps, expansion is performed by connecting a new stump only to the left-side child node of the target stump for connection.

8. A generation device comprising:
a processor configured to:
generate a tree structure of stumps, each of which represents smallest binary tree and has a root and two child nodes, which are a left-side child node and a right-side child node, by performing expansion according to a predetermined expansion method by connecting the root of another stump to at least either one of the two child nodes, which are the left-side child node and the right-side child node of a parent stump that does not have the root connected to another stump; and
generate a binary tree from the tree structure of stumps by developing each stump constituting the tree structure of stumps into a binary tree, wherein
in the predetermined expansion method,
in the tree structure of stumps, when target stump for connection is present in rightmost stump series, which is a series of stumps obtained by tracking stumps from the parent stump via stumps connected to the right-side child nodes or via stumps connected to the left-side child nodes when there is no stump connected to the right-side child node, and is a marginal stump having no stump connected to the right-side child node and the left-side child node thereof, expansion is performed by connecting a new stump to right-side child node or left-side child node of the target stump for connection,
in the tree structure of stumps, when target stump for connection is a non-marginal stump present in the rightmost stump series of the tree structure of stumps, expansion is performed by connecting a new stump only to the right-side child node of the target stump for connection,
in the tree structure of stumps, when target stump for connection is a marginal stump present in leftmost stump series, which is a series of stumps obtained by tracking stumps from the parent stump via stumps connected to the left-side child nodes or via stumps connected to the right-side child nodes when there is no stump connected to the left-side child node, expansion is performed by connecting a new stump to the right-side child node or the left-side child node of the target stump for connection, and
in the tree structure of stumps, when target stump for connection is a non-marginal stump present in the leftmost stump series of the tree structure of stumps, expansion is performed by connecting a new stump only to the left-side child node of the target stump for connection.
